(19) United States
(12) Patent Application Publication
(10) Pub. No.: US 2013/0091355 A1
(43) Pub. Date: Apr. 11, 2013

(54) Techniques to Prevent Mapping of Internal Services in a Federated Environment

(71) Applicants: Eliot Lear, Wetzikon (CH); Klaas Wierenga, Utrecht (NL)

(72) Inventors: Eliot Lear, Wetzikon (CH); Klaas Wierenga, Utrecht (NL)

(73) Assignee: CISCO TECHNOLOGY, INC., San Jose, CA (US)

(21) Appl. No.: 13/253,182

(22) Filed: Oct. 5, 2011

(51) Int. Cl. H04L 9/32

(52) U.S. Cl. 713/168

(57) ABSTRACT

Techniques are provided for securely providing protected information within an enterprise network to a service provider located outside of the enterprise network. An identity provider device hashes an address associated with protected information within an enterprise network to obtain a hashed address and maintains a mapping of the hashed address to the address associated with the protected information within the enterprise network. An assertion is sent to a service provider outside of the enterprise network, which contains the hashed address. The service provider receives a request, including the hashed address contained in the sent assertion, to access the protected information within the enterprise network. The service provider or other authorized party can then gain access to the protected information within the enterprise network by relating the hashed address to the address associated with the protected information within the enterprise network according to the mapping.

### TECHNICAL FIELD

The present disclosure relates to electronic network security.

### BACKGROUND

An enterprise network is a network that interconnects a plurality of computers, routers and switches on behalf of a single entity, such as a large corporation or government agency. Thus, users or company employees can communicate within the enterprise network and can access company websites and other resources even though the employees may be located at large distances from one another. At times, a service provider, external to the enterprise network, may offer services to the enterprise network (e.g., at the request of the users). Some computing environments may allow authorized external service providers some level of access to an enterprise network. Such environments are known as federated computing environments or networks. With appropriate access credentials, service providers can access the enterprise network. For example, enterprise users can request, via the enterprise network, services offered by the service providers. In addition, enterprise networks may pass information to computers or other devices associated with an enterprises user via the service providers (for example, an internal directory URI).

### BRIEF DESCRIPTION OF THE DRAWINGS

FIG. 1 is an example network topology that supports service provider access to protected information residing in an enterprise network.

FIG. 2 is an example block diagram of an identity provider device configured with address hashing and mapping logic to hash addresses associated with protected information and to retrieve the protected information via the mapping.

FIGS. 3A and 3B are examples of session database information comprising mapping information between hashed addresses and unhashed addresses associated with protected information.

FIG. 4 shows an example of a protected information database comprising mapping information between the unhashed addresses and associated protected information.

FIG. 5 shows an example flow chart depicting operations of the address hashing and mapping logic for authenticating a principal of the enterprise network to enable access to protected information.

FIG. 6 shows an example flow chart depicting operations of the address hashing and mapping logic for hashing addresses associated with protected information and mapping the hashed addresses to unhashed addresses.

### DESCRIPTION OF EXAMPLE EMBODIMENTS

Overview

Techniques are provided for obscuring the location of protected information in an enterprise network, and providing authorized access to that protected information within a limited timeframe to a service provider located outside of the enterprise network. An identity provider device hashes an address associated with protected information within an enterprise network to obtain a hashed address and maintains a mapping of the hashed address to the address associated with the protected information within the enterprise network. An assertion is sent to a service provider outside of the enterprise network, wherein the assertion contains the hashed address. A request, which includes the hashed address contained in the sent assertion, is received from the service provider to access the protected information within the enterprise network. The request including the hashed address may also be received by a device (e.g., computer) associated with an enterprise user. The service provider or enterprise user, via the associated device, is then enabled to gain access to the protected information within the enterprise network by relating the hashed address to the address associated with the protected information within the enterprise network according to the mapping. These techniques allow the service provider to obtain protected information hosted by the enterprise network without receiving information about the native address and other network parameters associated with the protected information and enterprise network.

### Example Embodiments

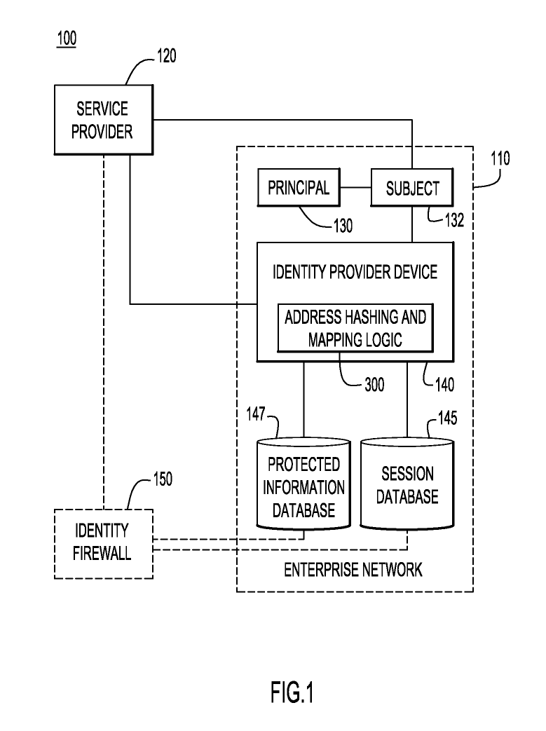

FIG. 1 shows an example network topology 100 featuring an enterprise network 110 and a service provider 120 located outside of the enterprise network 110. The network topology 100 in FIG. 1 is an example of a federated topology whereby the service provider 120 can function, from an internal enterprise network user's perspective, as a part of the enterprise network 110 and gain access to information hosted by the enterprise network 110. The service provider 120 can gain access to the information hosted by the enterprise network 110 without gaining access to highly sensitive information (e.g., native addresses) associated with the domain of the enterprise network 110.

As shown in FIG. 1, the enterprise network 110 includes a principal 130, a subject 132, an identity provider device 140, a protected information database 147 and a session database 145. The principal 130 may be a user (e.g., a human or machine user) in communication with the service provider 120. The subject 132 may be any network device that is associated with the principal 130 and that is configured to communicate with the service provider 120, the principal 130 and the identity provider device 140. In one example, the subject 132 associated with the principal 130 may comprise a computing device (e.g., laptop computer, desktop computer, mobile phone, tablet device, etc.) configured to communicate with the service provider 120 and the identity provider device 140. It should be appreciated that the principal 130 and subject 132 may reside outside of the enterprise network 110, but for simplicity, FIG. 1 shows the principal 130 and subject 132 as residing within the enterprise network 110.

The identity provider device 140 of the enterprise network 110 is configured to communicate with the service provider 120, the subject 132, the protected information database 147 and the session database 145. Likewise, the service provider 120 and the subject 132 are configured to communicate with each other, as well as with the identity provider device 140. In one example, as described in more detail herein, the service provider 120 and the subject 132 are configured to exchange communications with each other and with the identity provider device 140 to request and receive access to protected information stored in the protected information database 147 of the enterprise network 110.

In another example, as described in more detail herein, the identity provider device 140 is configured to exchange communications with the service provider 120 and the subject 132 in order to authenticate the subject 132, to receive requests from the service provider 120 or the subject 132 for access to protected information in the protected information database 147, and to transmit hashed or encrypted address information associated with the protected information to the service provider 120 or the subject 132. In this example, the service provider 120 or the subject 132 can utilize the hashed or encrypted address to obtain access to the protected information from the enterprise network 110 without gaining access to highly sensitive information (e.g., native address information associated with the protected information) of the enterprise network 110.

The protected information database 147 of the enterprise network 110 is configured to store protected information and unhashed addresses (e.g., uniform resource identifier (URI) addresses) associated with the protected information. The information stored in the protected information database 147 can be retrieved by the identity provider device 140 at the request of the service provider 120 or the subject 132, upon proper authentication and authorization of the service provider 120 or the subject 132 as the case may be. The identity provider device 140 can utilize information stored in the session database 145 to perform this authentication and authorization of the service provider 120 and the subject 132 before providing the service provider 120 and the subject 132 access to the protected information in the protected information database 147.

For example, as described in more detail herein, the session database 145 stores a mapping maintained by the identity provider device 140 between multiple service providers, native (e.g., unhashed) addresses associated with protected information stored in the protected information database 147 and hashed addresses associated with the unhashed addresses. When a service provider (e.g., service provider 120) makes a request, with a hashed address, to the identity provider device 140 for protected information, the identity provider device 140 can look-up information in the session database 145 to determine whether or not the service provider 120 is authorized to obtain the protected information. If the service provider 120 is authorized, the identity provider device 140 can look-up information in the session database 145 to map the hashed address in the request with a native, unhashed address associated with the protected information. The native, unhashed address leads the identity provider device 140 to the appropriate entry in the protected information database 147 to enable the service provider device 120 to obtain access to the protected information. Once so accessed, or at a later specified time or event, the hash mapping is removed. These techniques are described in more detail herein.

FIG. 1 also shows an optional identity firewall 150 in communication with the service provider 120. As shown, the identity firewall 150 may be configured to communicate with the service provider 120, and with the identity provider device 140, protected information database 147 and session database 145 of the enterprise network 110. It should be appreciated that the identity firewall 150 may be a device (e.g., a proxy device) separate from the identity provider device 140 or may be the identity provider device 140 itself. Thus, the identity firewall 150 may reside within the enterprise network 110 or outside of the enterprise network 110. For simplicity, the optional identity firewall 150 is shown as a separate firewall device on the border of the enterprise network 110. In one example, the identity provider device 140 may enable the service provider 120 to access protected information within the protected information database 147 via the identity firewall 150, e.g., such that the identity firewall 150 proxies (e.g., “masks”) address information (hashed or unhashed addresses) associated with the requested protected information stored in the protected information database 147. In another example, the identity firewall 150 translate address information (e.g., between hashed and unhashed addresses) associated with the requested protected information.

As shown in FIG. 1, the identity provider device 140 is configured with address hashing and mapping logic 300 to hash addresses associated with protected information requested by, e.g., service provider 120, and to map these hashed address to unhashed (e.g., native) addresses associated with the protected information, as described herein.

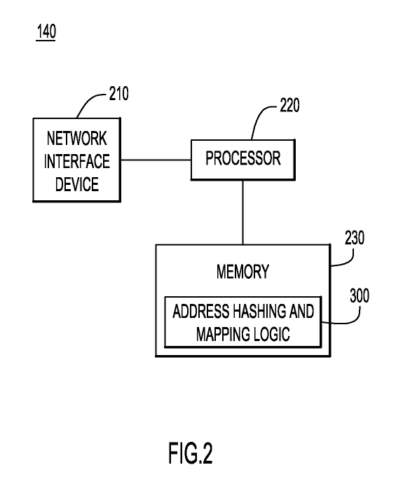

Turning to FIG. 2, an example block diagram of the identity provider device 140 is shown. The identity provider device 140 comprises a network interface device 210, a processor 220 and a memory 230. The network interface device 210 is configured to enable network communications, for example, to receive requests from the service provider 120 for protected information and to transmit hashed addresses associated with protected information to the service provider 120. The network interface device 210 is also configured to enable network communications, for example, to transmit authentication tokens (e.g., an authentication cookie) to the subject 132 to authenticate and authorize the subject 132 for access to appropriate protected information, as described herein. Processor 220 is coupled to network interface device 210 and to memory 230. Processor 220 may be a microprocessor or microcontroller that is configured to execute program logic instructions (i.e., software) for carrying out various operations and tasks described herein. For example, processor 220 may be configured to execute address hashing and mapping logic 300 that is stored in memory 230 to hash addresses associated with protected information and to map the hashed addresses to unhashed or native addresses associated with the protected information. Memory 230 may comprise read only memory (ROM), random access memory (RAM), magnetic disk storage media devices, optical storage media devices, flash memory devices, electrical, optical or other physical/tangible memory storage devices.

The functions of processor 220 may be implemented by logic encoded in one or more tangible computer readable storage media (e.g., embedded logic such as an application specific integrated circuit, digital signal processor instructions, software that is executed by a processor, etc), wherein memory 230 stores data used for the operations described herein and stores software or processor executable instructions that are executed to carry out the operations described herein.

Address hashing and mapping logic 300 may take any of a variety of forms, so as to be encoded in one or more tangible computer readable memory media or storage device for execution, such as fixed logic or programmable logic (e.g., software/computer instructions executed by a processor) and the processor 220 may be an application specific integrated circuit (ASIC) that comprises fixed digital logic, or a combination thereof. For example, the processor 220 may be embodied by digital logic gates in a fixed or programmable digital logic integrated circuit, which digital logic gates are configured to perform address hashing and mapping logic 300. In general, address hashing and mapping logic 300 may be embodied in one or more computer readable storage media encoded with software comprising computer executable instructions and when the software is executed operable to perform the operations described herein for the process logic 300.

As described above with reference to FIG. 1, the identity provider device 140 is configured to enable the service provider 120 to access protected information stored in the protected information database 147. In general, the principal 130 (via the subject 132) will make a request for services to be provided to it by the service provider 120. In order to perform these requested services, the service provider 120 may need to access the protected information in the protected information database 147.

For example, the principal 130 may request, via a web browser of the subject 132, new business cards from the service provider 120, which may be a website service that provides business cards to customers. The principal 130 makes the request for business cards, and the web browser of the subject 132 is directed to the service provider 120 (e.g., to a website hosted by the service provider 120). In order to fulfill the request for business cards from the principal 130, the service provider 120 may need access to protected information associated with the principal 130. For example, the service provider 120 may need access to the telephone number, mailing address, email address, job title, company information and other personal information associated with the principal 130. This information may be stored in the protected information database 147 of the enterprise network 110.

Since the service provider 120 is not part of the enterprise network 110, it may not be desirable to grant the service provider 120 full access to all of the information in the protected information database 147 of the enterprise network 110, particularly information that can lead to address mapping within the enterprise network 110. That is, since the service provider 120 is not part of the enterprise network 110, if the native addresses were provided to the service provider 120, a snooping entity outside of the enterprise network 110 (or the service provider 120 itself) may be able to gain access to other protected information that is not required by the request from the principal 130 by, for example, deriving addresses associated with this other information from the native addresses. For example, the service provider 120 may be able to utilize the native addresses to obtain unauthorized information about the principal 130 or unauthorized information about other users (e.g., employees) of the enterprise network 110. In addition, knowledge of the actual location of the protected information is valuable to attackers. Thus, unauthorized users may be able to obtain other unauthorized information for other users via the subject 132. In order to prevent such attacks, it may be preferable to obscure these native addresses.

In accordance with an embodiment, the service provider 120 is given only limited access to information in the protected information database 147 and access to this information (e.g., address information associated with the information) may be encrypted or hashed so that the service provider 120 is not aware of the native, unhashed address. Thus, in the business card example, after the web browser of the subject 132 is directed to the service provider 120, the service provider 120 redirects the web browser of the subject 132 to the identity provider device 140. The identity provider device 140 then initiates an authentication and authorization for the subject 132, and upon authenticating and authorizing the user, the identity provider device 140 sends a signed assertion to the service provider 120. The signed assertion contains a hashed (e.g., masked/encrypted) URI address which, when accessed by the service provider 120, allows the service provider 120 to obtain the protected information in the protected information database 147 needed to fulfill the request by the principal 130 (via the subject 132) for the business cards.

The identity provider device 140 can authenticate and authorize the principal 140 in several ways. In one example, the identity provider device 140 verifies a user name and password that is entered by the principal 130 (via the subject 132), and if the user name and password are authentic, the identity provider device 140 sends an authentication token (e.g., a cryptographic cookie) to the subject 132.

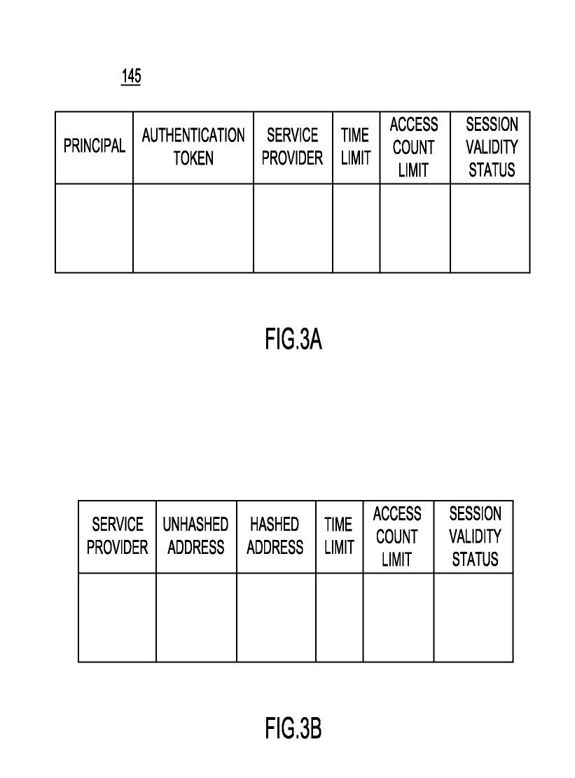

The identity provider device 140 may send the authentication token directly to the web browser of the subject 132 or may send the authentication token to the subject 132 by other known programmatic means (e.g., in accordance with a simple authentication security layer (SASL), generic security service (GSS), GSS-application program interface (GSS-API), etc.) The identity provider device 140 stores the authentication information in the session database 145, which is depicted in FIGS. 3A and 3B and is now described.

FIGS. 3A and 3B show examples of information stored in the session database 145. In FIG. 3A, multiple principal devices (e.g., subject 132) are mapped to authentication tokens which are provided to the principals, service providers associated with the principals, time limits for the authentication tokens provided to the principals, access count limits and a status indicating session validity. In FIG. 3B, multiple service providers (e.g., service provider 120) are mapped to native, unhashed addresses associated with protected information entries in the protected information database 147, described in more detail herein. The multiple service providers are also mapped to hashed addresses which are generated by the identity provider device 140 and associated with the native, unhashed addresses. Furthermore, the multiple service providers may be mapped to time limits, access count limits and a status indicating session validity associated with each of the hashed addresses.

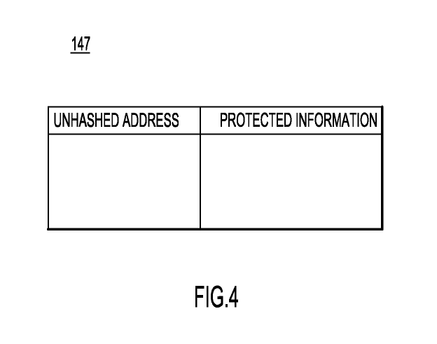

Reference is now made to FIG. 4. FIG. 4 shows an example of information stored in the protected information database 147. In FIG. 4, the protected information database 147 stores multiple entries for protected information, and the entries are mapped to corresponding unhashed URI addresses. In turn, as shown in FIGS. 3A and 3B, each unhashed address is mapped to hashed addresses in the session database 145. Thus, the identity provider device 140, by virtue of accessing the protected information database 147 and the session database 145, can map hashed addresses (e.g., received in requests from a service provider) to entries of protected information in the protected information database 147.

As stated above, for security purposes, it may not be desirable for the identity provider device 140 to provide unhashed URI addresses directly to the service provider 120 and the subject 132. For example, the unhashed URI addresses may contain information within the address itself that would allow the service provider 120 or an attacker if the service provider 120 is compromised to access other, unauthorized information in the enterprise network 110. In another example, if an unhashed URI address is sent to the service provider 120, a “snooping” or otherwise malicious, unauthorized entity may be able to obtain the unhashed URI address from the service provider 120 and may utilize the unhashed URI address to gain access to the enterprise network 110. In order to prevent such unauthorized access, the identity provider device 140 may mask (or “hash”) these URI addresses to prevent the service provider 120 from having access to the native, unhashed URI addresses. The unhashed URI addresses are hashed into a format that does not reveal the unhashed URI address information.

When the identity provider device 140 hashes the URI addresses associated with the protected information, the identity provider device 140 may also set a limited timeframe or “lifespan” for the hashed URI address. The limited timeframe or “lifespan” of the hashed URI address causes the hashed URI address to be valid only for a certain period of time. The identity provider device 140 stores the hashed address information in the session database 145, as shown in FIGS. 3A and 3B. For example, as shown in FIG. 3B, the session database maintains a mapping of the hashed addresses that are sent to service providers, as described herein, and corresponding unhashed addresses and limited timeframe for the hashed addresses.

In one example, an unhashed URI address (e.g., https://unhashed) associated with protected information is hashed by the identity provider device 140 to obtain a hashed address (e.g., https://hashed). Accordingly, upon proper authentication and verification, the service provider 120 can obtain the protected information associated with https://unhashed via https://hashed. In one example, the service provider 120 may also pass the hashed address to the web browser of the subject 132 associated with the principal 132. This hashed URI address is valid only for a predetermined amount of time (e.g., the hashed URI is ephemeral) or for a predetermined number of accesses, according to a policy set by the identity provider device 140. In one example, the hashed URI may also be passed to a web browser of the subject 132 by the service provider 120.

After the predetermined amount of time has expired, an access count has been exceeded or a session has expired, https://hashed is no longer associated with https://unhashed, and thus, the service provider 120 (or subject 132) can no longer gain access to the protected information associated with https://unhashed via https://hashed. As an example, the predetermined period of time for the hashed URI address can have the same time limit as the lifespan of the authentication token supplied to the subject 132.

However, before the service provider 120 can request the information, the service provider 120 needs to be “made aware” of a given hashed URI address. In other words, the service provider 120 needs to be provided with the hashed URI address before the service provider 120 can request access for protected information using the hashed URI addresses. In order to accomplish this, after the identity provider device 140 performs the hashing, the identity provider device 140 initiates a security assertion exchange with the service provider 120 to verify the authenticity and authorization credentials of the service provider 120. In the course of this security assertion exchange, the identity provider device 140 informs the service provider 120 of the given hashed URI address. The service provider 120 can then request protected information associated with the hashed URI address that it received from the identity provider device 140 during the security exchange.

In one example, the identity provider device 140 may initiate a Security Assertion Markup Language (SAML) exchange between the identity provider device 140 and the service provider 120. In this example, the identity provider device 140 may create the SAML assertion and may encode within the SAML assertion the hashed URI address that is mapped (e.g., in the session database 145) to an unhashed address associated with protected information.

SAML is a protocol for exchanging assertions about authentication and attributes associated with the principal 130 and subject 132. The authentication attributes allow the service provider 120 to establish a trust relationship with the identity provider device 140, which allows the service provider 120 to rely upon the identity provider device 140 assertions as being true. For example, if the identity provider device 140 indicates (e.g., via the SAML assertion) that the principal 130 (and subject 132) has been authenticated and provides a hashed address mapped to an unhashed address associated with protected information to the service provider device, the service provider 120 will be able to obtain access to the protected information by making a request for the information via the hashed address. It should be appreciated that though SAMLassertions are described herein, any signed assertion can be generated and sent to the client device 110 by the identity provider device 140 to effect the functionality described herein.

In response to receiving the signed assertion, the service provider 120 sends a request to the identity provider device 140 for information associated with the hashed address that it received during the security exchange. Thus, the service provider 120 is able to request, via the hashed address, the protected information from the identity provider device 140. The hashed address may contain information mapped to the unhashed address along with a number-used-once (nonce) that is unique to each unhashed address. The nonce, for example, can serve as a unique key to associate the hashed and unhashed addresses. The service provider 120 may pass the hashed addresses to the subject 132 or to any authorized party. For example, the hashed address may be an employee directory entry which may be referenced by a web browser associated with the subject 132.

When the service provider 120 (or subject 132) attempts to access the hashed address provided to it by the identity provider device 140, the identity provider device 140 queries the session database 145 to retrieve the authentication token to verify that the subject 132 (making the request for protected information via the service provider 120) is indeed authentic. Alternatively, the service provider 120 may query the identity firewall 150, which may, for example, have access to the session database 145 and the protected information database 147 (shown in FIGS. 3A, 3B and 4) to obtain the protected information.

After the subject 132 is verified, the identity provider device 140 either redirects the service provider 120 to the protected information associated with the unhashed address or supplies the protected information directly to the service provider 120 via the identity firewall 150. In one example, the identity firewall 150 is a proxy device that acts as a proxy for the unhashed address and is used between the service provider 120 and the identity provider device 140 in order to provide access to the protected information. Regardless of whether a redirect or proxy is used, the service provider 120 or subject 132 is not made aware of the mapping between the hashed address and unhashed address. In other words, the service provider 120 and subject 132 may receive access to the protected information, but they will not receive information relating to the native, unhashed address associated with the protected information. In one example, the identity firewall 150 will translate between hashed and unhashed addresses in order to provide the service provider 120 and subject 132 with the protected information.

For example, for relatively simple services, such as network selector operations, the identity provider device 140 may supply the protected information to the service provider 120 via the identity firewall 150, while for more relatively complex services, a redirect might be more advisable. In another example, the identity provider device 140 may redirect the service provider 120 to the protected information associated with the unhashed address in order to reduce network throughput through the identity provider device 140. Additionally, the identity provider device 140 may cause the information to be delivered to the service provider 120 via the identity firewall 150 to further protect the enterprise network 110 from attacks.

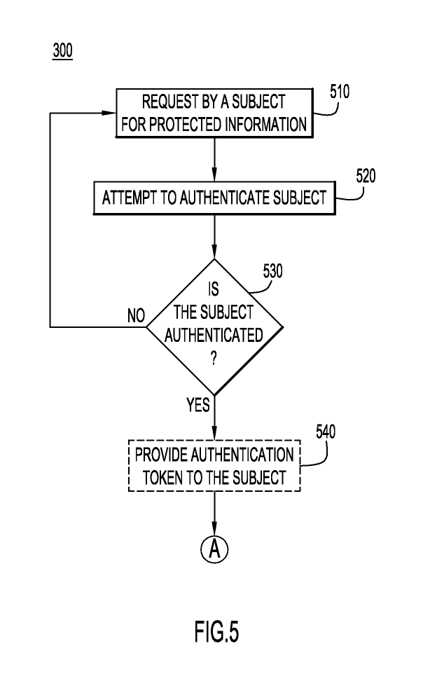

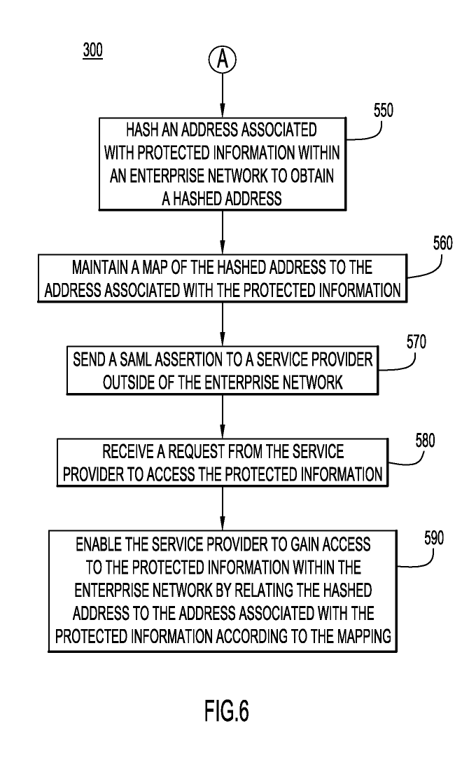

Reference is now made to FIGS. 5 and 6. FIGS. 5 and 6 show example flow charts depicting operations for the address hashing and mapping logic 300 of the identity provider device 140. Referring first to FIG. 5, at 510, a request is received at the identity provider device 110 from subject 132 (e.g., via the service provider 120) for a service that involves access to protected information. For example, the request may be a request from the subject 132 to receive business cards, as described above. After the request is received, the identity provider device 140, at 520 attempts to authenticate the subject 132, as described above. The identity provider device 140 determines, at 530, whether the subject 132 is authentic, for example, by verifying a user name and password entered by the principal 130 at subject 132. If the subject 132 is authentic (i.e., if the answer to the decision 530 is “yes”), the identity provider device 140 optionally, at 540, provides an authentication token to the subject 132, as described above. If the subject 132 is not authentic (i.e., if the answer to decision 430 is “no”), the identity provider device 140 waits for another request 510 for protected information to be received.

Referring now to FIG. 6, after the identity provider device 140 determines that the subject 132 is authentic, the identity provider device 140, at 550, hashes an address (e.g., an unhashed URI address) associated with the protected information within the enterprise network 120 to obtain a hashed address (e.g., a hashed URI address). At 560, the identity provider device 140 maintains a map of the hashed address to the address associated with the protected information. The identity provider device 140 may maintain this mapping by storing the hashed addresses and unhashed addresses in the session database 145, as described above. It should be noted that the address hashing and mapping may be performed before any request from a user is received. Once the mapping is established, the identity provider device 140 sends a SAML assertion, at 570, to the service provider 120, which may reside outside of the enterprise network 110 in a federated configuration, as described above. The assertion includes the hashed address, which the service provider 120 can utilize to request access to the protected information.

At some point after sending the assertion, the identity provider device 140 receives a request, at 480, from the service provider 120 or another authorized party who has been given the URI by service provider 120 to access the protected information. At 590, after receiving the request from the service provider 120, the identity provider device 140 enables the service provider 120 to gain access to the protected information within the enterprise network 110 by relating the hashed address to the address associated with the protected information according to the mapping.

As described above, the protected information database 147 contains entries of hashed URIs mapped to corresponding unhashed URIs. Thus, the identity provider device 140, by accessing the protected information database 147 and the session database 145 is aware of the mapping between the hashed addresses, unhashed address and protected information. As a result, the identity provider device 140 can provide access to the service provider 120 or other authorized party to the appropriate protected information of the protected information database 147.

It should be appreciated that the techniques described above in connection with all embodiments may be performed by one or more computer readable storage media that is encoded with software comprising computer executable instructions to perform the methods and steps described herein.

In sum, a method is provided comprising: at an identity provider, hashing an address associated with protected information within an enterprise network to obtain a hashed address; maintaining a mapping of the hashed address to the address associated with the protected information within the enterprise network; sending an assertion to a service provider or other authorized party outside of the enterprise network, wherein the assertion contains the hashed address; receiving a request from the service provider or the other authorized party to access the protected information within the enterprise network, the request including the hashed address contained in the assertion; and enabling the service provider or the other authorized party to gain access to the protected information within the enterprise network by relating the hashed address to the address associated with the protected information within the enterprise network according to the mapping.

In addition, an apparatus is provided, comprising: a network interface device; a memory coupled to the network interface device; and a processor coupled to the network interface device and the memory, and configured to: hash an address associated with protected information within an enterprise network to obtain a hashed address; maintain a map of the hashed address to address associated with the protected information within the enterprise network; send an assertion to a service provider or other authorized party outside of the enterprise network, wherein the assertion contains the hashed address; receive a request from the service provider or the other authorized party to access the protected information within the enterprise network, the request including the hashed address contained in the sent assertion; and enable the service provider or the other authorized party to gain access to the protected information within the enterprise network by relating the hashed address to the address associated with the protected information within the enterprise network according to the mapping.

Furthermore, one or more computer readable storage media encoded with software is provided comprising computer executable instructions and when the software is executed operable to: hash an address associated with protected information within an enterprise network to obtain a hashed address; maintain a map of the hashed address to address associated with the protected information within the enterprise network; send an assertion to a service provider outside of the enterprise network, wherein the assertion contains the hashed address; receive a request from the service provider to access the protected information within the enterprise network, the request including the hashed address contained in the sent assertion; and enable the service provider to gain access to the protected information within the enterprise network by relating the hashed address to the address associated with the protected information within the enterprise network according to the mapping.

The above description is intended by way of example only. Various modifications and structural changes may be made therein without departing from the scope of the concepts described herein and within the scope and range of equivalents of the claims.

What is claimed is:

1. A method comprising:
at an identity provider device, hashing an address associated with protected information within an enterprise network to obtain a hashed address;
maintaining a mapping of the hashed address to the address associated with the protected information within the enterprise network;
sending an assertion to a service provider or other authorized party outside of the enterprise network, wherein the assertion contains the hashed address;
receiving a request from the service provider or the other authorized party to access the protected information within the enterprise network, the request including the hashed address contained in the assertion; and
enabling the service provider or the other authorized party to gain access to the protected information within the enterprise network by relating the hashed address to the address associated with the protected information within the enterprise network according to the mapping.

2. The method of claim 1, wherein hashing comprises hashing the address associated with the protected information within the enterprise network such that the hashed address is valid for a predetermined amount of time or for a predetermined number of accesses or both.

3. The method of claim 2, further comprising determining by the identity provider device whether a subject in communication with the identity provider device and the service provider is authenticated and authorized to access the protected information within the enterprise network.

4. The method of claim 1, further comprising providing by the identity provider device an authentication token to a subject when the identity provider device determines that the subject is authenticated and authorized.

5. The method of claim 4, wherein hashing comprises hashing the address associated with the protected information within the enterprise network such that the hashed address is valid for a predetermined amount of time, a predetermined number of accesses, or a session status based on the authentication token provided to the subject.

6. The method of claim 1, wherein the identity provider device performs the hashing when a subject in communication with the identity provider device is determined to be authenticated and authorized to access the address associated with protected information within the enterprise network.

7. The method of claim 1, wherein hashing comprises hashing a uniform resource indicator (URI).

8. The method of claim 7, wherein enabling comprises enabling the service provider to gain access to the protected information within the enterprise network via an identity firewall that is in communication with the identity provider device.

9. The method of claim 7, wherein enabling comprises enabling the service provider to gain access to the protected information within the enterprise network by redirecting the service provider to the unhashed address.

10. The method of claim 1, wherein hashing further comprises cryptographically hashing the address associated with the protected information within the enterprise network along with a number-used-once that is unique to the hashed address.

11. The method of claim 1, wherein sending comprises sending the assertion in accordance with one of a security association markup language (SAML) assertion or similar assertion language.

12. An apparatus comprising:
a network interface device;
a memory coupled to the network interface device; and
a processor coupled to the network interface device and the memory, and configured to:
hash an address associated with protected information within an enterprise network to obtain a hashed address;
maintain a map of the hashed address to address associated with the protected information within the enterprise network;
send an assertion to a service provider or other authorized party outside of the enterprise network, wherein the assertion contains the hashed address;
receive a request from the service provider or the other authorized party to access the protected information within the enterprise network, the request including the hashed address contained in the sent assertion; and
enable the service provider or the other authorized party to gain access to the protected information within the enterprise network by relating the hashed address to the address associated with the protected information within the enterprise network according to the mapping.

13. The apparatus of claim 12, wherein the processor is further configured to hash the address associated with the protected information within the enterprise network such that the hashed address is valid for a predetermined amount of time or for a predetermined number of accesses or both.

14. The apparatus of claim 12, wherein the processor is further configured to determine whether a subject in communication with the service provider is authenticated and authorized to access the protected information within the enterprise network.

15. The apparatus of claim 12, wherein the processor is further configured to provide an authentication token to a subject when it is determined that the subject is authenticated and authorized.

16. The apparatus of claim 15, wherein the processor is further configured to hash the address associated with the protected information within the enterprise network such that the hashed address is valid for a predetermined amount of time, a predetermined number of accesses or a session status based on the authentication token provided to the principal.

17. One or more computer readable storage media encoded with software comprising computer executable instructions and when the software is executed operable to:
hash an address associated with protected information within an enterprise network to obtain a hashed address;
maintain a map of the hashed address to address associated with the protected information within the enterprise network;
send an assertion to a service provider or other authorized party outside of the enterprise network, wherein the assertion contains the hashed address;
receive a request from the service provider or the another authorized party to access the protected information within the enterprise network, the request including the hashed address contained in the sent assertion; and
enable the service provider or the other authorized party to gain access to the protected information within the enterprise network by relating the hashed address to the address associated with the protected information within the enterprise network according to the mapping.

18. The computer readable storage media of claim 17, further comprising instructions operable to hash the address associated with the protected information within the enterprise network such that the hashed address is valid for a predetermined amount of time or for a predetermined number of accesses or both.

19. The computer readable storage media of claim 17, further comprising instructions operable to determine whether a subject is authenticated and authorized to access the protected information within the enterprise network.

20. The computer readable storage media of claim 17, further comprising instructions operable to provide an authentication token to a subject when it is determined that the subject is authenticated and authorized.
